(19) United States
(12) Patent Application Publication
(10) Pub. No.: US 2019/0283730 A1
(43) Pub. Date: Sep. 19, 2019

(54) CONTROL SYSTEM FOR HYBRID VEHICLE

(71) Applicant: TOYOTA JIDOSHA KABUSHIKI KAISHA, Toyota-shi (JP)

(72) Inventors: Atsuharu OTA, Mishima-shi (JP); Yoshiaki MIYAZATO, Sunto-gun (JP)

(73) Assignee: TOYOTA JIDOSHA KABUSHIKI KAISHA, Toyota-shi (JP)

(21) Appl. No.: 16/292,245

(22) Filed: Mar. 4, 2019

(30) Foreign Application Priority Data
Mar. 19, 2018 (JP) 2018-051533

(51) Int. Cl. B60W 20/10; B60W 10/06; B60W 10/08; B60W 10/26

(52) U.S. Cl. CPC B60W 20/10; B60W 10/06; B60W 10/08; B60W 10/26; B60Y 2200/92; B60W 2710/0644; B60W 2510/087; B60W 2510/244; B60W 2510/246; B60W 2710/0666; B60W 2510/0676

(57) ABSTRACT

A control system for a hybrid vehicle configured to prevent a shortage of drive force to accelerate the hybrid vehicle as desired by a driver, even when an output power of a battery is reduced at low temperature. The hybrid vehicle comprises: an engine; a first motor; a battery charged with electricity generated by the first motor; and a second motor operated by electricity supplied from the battery to generate drive torque. If a large power is required when output performance of the battery is reduced due to low temperature, a controller temporarily increases an output torque of the engine thereby operating the first motor to generate an electric power.

### CROSS REFERENCE TO RELATED APPLICATIONS

The present application claims the benefit of priority to Japanese Patent Application No. 2018-051533 filed on Mar. 19, 2018 with the Japanese Patent Office, the entire contents of which are incorporated herein by reference in its entirety.

### BACKGROUND

### Field of the Disclosure

Embodiments of the disclosure relate to the art of a hybrid vehicle in which a prime mover includes an engine and a motor having a power generation function.

### Discussion of the Related Art

JP-A-2008-273518 describes a control system for a battery of a hybrid vehicle configured to reduce a fuel consumption at low temperature without shortening a battery life, and without increasing a cost and weight of the hybrid vehicle. According to the teachings of JP-A-2008-273518, the control system is configured to set an allowable time to continuously supplying or discharging current to/from the rechargeable secondary battery of the hybrid vehicle according to the temperature of the battery of the hybrid vehicle, and to execute a charging and a discharging of the battery within the allowable time when a temperature is low. The control system taught by JP-A-2008-273518 is further configured to an upper limit voltage and a lower limit voltage applied and outputted to/from the battery. Specifically, when the temperature of the battery is low, the upper limit value of the output voltage is set to a higher level than the upper limit value of a case in which the temperature of the battery is high. On the other hand, the lower limit value of the input voltage is set to a level lower than the lower limit value of the case in which the temperature of the battery is high.

Generally, in the secondary battery for a motor used as a prime mover of a hybrid vehicle or an electric vehicle, the reaction rate of a chemical reaction resulting from charging and discharging the battery changes depending on a temperature. For example, when the temperature is low, it is difficult to discharge from the battery compared to the normal temperature, and hence an input/output performance of the secondary battery is reduced. In order to prevent reduction in battery life and to reduce fuel consumption at low temperature, according to the teachings of JP-A-2008-273518, the upper limit value of the output voltage is increased and the lower limit value of the input voltage is reduced at low temperature. However, according to the teachings of JP-A-2008-273518, the allowable time to continuously charging the battery and discharging from the battery is reduced to expand an allowable range of the voltage to be inputted and discharged to/from the battery. For this reason, when the temperature of the battery is low, an output power from the battery has to be reduced compared to that at normal temperature. Consequently, an output power of the hybrid system may be reduced, and hence a required drive force may not be achieved to accelerate the vehicle as desired at low temperature.

Such reduction in the output of the battery at low temperature may be a problem especially in a plug-in hybrid vehicle, a series hybrid vehicle, and a range extender electric vehicle. For example, in the plug-in hybrid vehicle, the secondary battery is charged using an external power source, and the plug-in hybrid vehicle is powered by the secondary battery more often compared to the hybrid vehicle in which the battery may not be charged by the external power source. On the other hand, in the series hybrid vehicle including the range extender electric vehicle, an engine is used only to drive a generator, and the vehicle is powered only by the motor. In those kinds of hybrid vehicles, therefore, a shortage of the drive force resulting from reduction in the output power of the battery may be a serious problem.

### SUMMARY

Embodiments of the present disclosure have been conceived noting the above-explained technical problems, and it is therefore an object of the present disclosure to provide a control system for a hybrid vehicle configured to prevent a reduction in an output power of a hybrid system to accelerate the hybrid vehicle as desired by a driver, even when an output power of a battery is reduced at low temperature.

The control system according to the exemplary embodiment of the present disclosure is applied to a vehicle comprising: an engine; a first motor that has a generation function, and that translates an output power of the engine into an electric power; a secondary battery that is charged with the electric power generated by the first motor; and a second motor that translates an electric power supplied from the secondary battery into torque to be delivered to drive wheels to establish a drive force. The control system is provided with a controller that controls the engine, the first motor, the second motor, and the secondary battery. The controller is configured to increase an output torque of the engine compared to an output torque of the engine to be generated to achieve a required output power by a driver at normal temperature thereby operating the first motor to generate an electric power, when the required output power is greater than a predetermined power, and output performances of the secondary battery and the engine are changed due to low temperature.

In a non-limiting embodiment, the controller may be further configured to: shift an operating point of the engine temporarily from a current point to a temporal point at which the output torque of the engine is increased when a temperature is low; and further shift the operating point from the temporal point to a normal point, which is set based on the required output power at the normal temperature, and at which the output torque of the engine is smaller than that at the temporal point and a speed of the engine is higher than that at the temporal point.

In a non-limiting embodiment, the controller may be further configured to shift the operating point of the engine from the temporal point to the normal point before a temperature of the first motor reaches a predetermined level.

In a non-limiting embodiment, the controller may be further configured to temporarily increase the output torque of the engine, and to increase the speed of the engine more promptly compared to a case of controlling the speed of the engine based on the required output power at the normal temperature, when a temperature of coolant water for cooling the engine is equal to or higher than a predetermined level.

In a non-limiting embodiment, the controller may be further configured to temporarily increase the output torque of the engine, and to increase the speed of the engine more promptly compared to a case of controlling the speed of the engine based on the required output power at the normal temperature, when a state of charge level of the secondary battery is equal to or lower than a predetermined level.

In a non-limiting embodiment, the engine may be used not only to drive the first motor by the output torque generated by the engine, but also to establish the drive force by delivering the output torque generated by the engine to the drive wheels.

Thus, according to the embodiment of the present disclosure, the engine torque is temporarily to operate the first motor as a generator when the temperature is low. When the temperature is low, the output performance of the battery is reduced, but air density increases as compared to the case in which the temperature falls within the normal range so that an occurrence of knocking of the engine is prevented. At low temperature, therefore, the output performance of the engine can be enhanced to generate larger torque than that at the normal temperature. According to the exemplary embodiment of the present disclosure, therefore, the engine torque is increased when the temperature is low so as to increase a generation amount of the first motor. For this reason, reduction in the output power to propel the hybrid vehicle can be prevented even when the temperature is low. In other words, shortage of the drive force can be avoided to accelerate the hybrid vehicle as desired by a driver even when the output performance of the secondary battery is reduced due to low temperature.

Specifically, when the large output power is required at low temperature, the operating point of the engine is temporarily shifted from the current point to the temporal point at which the output torque of the engine is increased, and further shifted from the temporal point to the normal point, which is set based on the required output power at the normal temperature, and at which the output torque of the engine is lower than that at the temporal point and the speed of the engine is higher than that at the temporal point. According to the exemplary embodiment of the present disclosure, therefore, reduction in the output power to propel the hybrid vehicle due to reduction in the output performance of the secondary battery at low temperature can be compensated by thus increasing the engine torque to generate more electricity by the first motor.

As a result of increasing the engine torque, a regenerative torque of the first motor would be increased, and the temperature of the first motor 2 would be raised. According to the exemplary embodiment, however, the operating point of the engine is shifted from the temporal point to the normal point before the temperature of the first motor reaches a maximum allowable level. According to the exemplary embodiment, therefore, overheating of the first motor can be prevented. In other words, the first motor will not be damaged thermally.

If the temperature of the coolant water is higher than the predetermined level, the engine torque may not be increased sufficiently. According to the exemplary embodiment, therefore, the engine speed is increased more promptly if the temperature of the coolant water is higher than the predetermined level when temporarily increasing the engine torque. For this reason, the output power of the engine can be increased promptly even if the temperature of the coolant water is higher than the predetermined level.

Likewise, if the state of charge level of the secondary battery is lower than the predetermined level, the output performance of the secondary battery may be reduced. According to the exemplary embodiment, therefore, the engine speed is increased more promptly if the state of charge level of the secondary battery is lower than the predetermined level when temporarily increasing the engine torque. For this reason, the output power of the engine can be increased promptly even if the state of charge level of the secondary battery is lower than the predetermined level. Consequently, the secondary battery may be charged quickly while compensating shortage of the output power to propel the hybrid vehicle.

The control system according to the exemplary embodiment of the present disclosure may be applied to a series-parallel hybrid vehicle in which the first motor is operated as a generator by the engine torque, and the drive force is established by delivering the engine torque to the drive wheels. In this case, when the large output torque is required at low temperature, the drive force and the generation amount can be increased directly by increasing the engine torque. In this case, therefore, reduction in the output power of the hybrid system can be compensated at low temperature by the drive force and the electricity thus increased.

### BRIEF DESCRIPTION OF THE DRAWINGS

Features, aspects, and advantages of exemplary embodiments of the present disclosure will become better understood with reference to the following description and accompanying drawings, which should not limit the invention in any way.

FIG. 1 is a schematic illustration schematically showing a structure of a series-parallel hybrid vehicle to which the control system according to the embodiment is applied;

FIG. 2 is a schematic illustration schematically showing a structure of a series hybrid vehicle to which the control system according to the embodiment is applied;

FIG. 3 is a flowchart showing one example of a routine executed by a controller of the hybrid vehicle;

FIG. 4 shows one example of a map for shifting an operating point of an engine during execution of the routine shown in FIG. 3;

FIG. 5 shows one example of a map for increasing an engine torque in accordance with a temperature of the battery;

FIG. 6 shows one example of a map for shifting the operating point of the engine in accordance with a temperature of the first motor;

FIG. 7 is a flowchart showing another example of a routine executed by the controller to increase the engine speed promptly when a temperature of a coolant of the engine is high;

FIG. 8 shows one example of a map for shifting the operating point of the engine during execution of the routine shown in FIG. 7;

FIG. 9 is a flowchart showing still another example of a routine executed by the controller to increase the engine speed promptly when a state of charge level of the battery is low; and

FIG. 10 shows one example of a map for shifting the operating point of the engine during execution of the routine shown in FIG. 9.

### DETAILED DESCRIPTION OF THE PREFERRED EMBODIMENT(S)

Preferred embodiments of the present disclosure will now be explained with reference to the accompanying drawings.

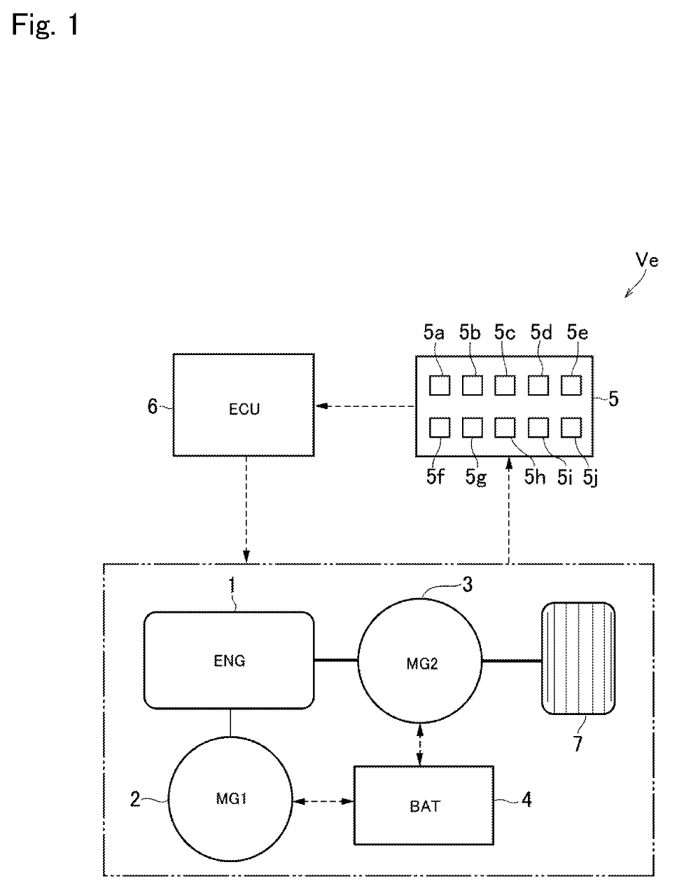

The control system according to the exemplary embodiment of the present disclosure is applied to a hybrid vehicle in which a prime mover includes an engine and at least two motors. In the hybrid vehicle, at least one of the motors has a generation function, and connected to an output shaft of the engine to be rotated by the engine to generate electricity. A torque generated by the engine may also be delivered to drive wheels to establish drive force to propel the hybrid vehicle. Turning now to FIG. 1, there is shown one example of a structure of a series-parallel hybrid vehicle in which electricity and drive force can be generated by the engine torque.

In a hybrid vehicle (as will be simply called the “vehicle” hereinafter) Ve illustrated in FIG. 1, a prime mover includes an engine (referred to as “ENG” in FIG. 1) 1, a first motor (referred to as “MG1” in FIG. 1) 2, and a second motor (referred to as “MG2” in FIG. 1) 3. The vehicle Ve comprises a battery (referred to as “BAT” in FIG. 1) 4, a detector 5, and a controller (referred to as “ECU” in FIG. 1) 6. In the vehicle Ve shown in FIG. 1, the first motor 2 is driven by a torque generated by the engine 1 to generate electricity, and the torque of the engine 1 is also delivered to drive wheels 7 to generate drive force.

For example, an internal combustion engine such as a gasoline engine and a diesel engine may be adopted as the engine 1. An output power of the engine 1 may be adjusted electrically, and the engine 1 may be started and stopped electrically according to need. Given that the gasoline engine is used as the engine 1, an opening degree of a throttle valve, an amount of fuel supply or fuel injection, and an ignition timing etc. may be controlled electrically. Otherwise, given that the diesel engine is used as the engine 1, an amount of fuel injection, an injection timing, an opening degree of a throttle valve of an Exhaust Gas Recirculation (EGR) system etc. may be controlled electrically.

For example, a permanent magnet type synchronous motor, and an induction motor may be adopted as the first motor 2, and the first motor 2 is connected to an output shaft la of the engine 1 to apply power generated by the engine 1 to the first motor 2. That is, the first motor 2 may serve not only as a motor to generate torque when driven by electricity suppled thereto, but also as a generator to generate (or regenerate) electricity when driven by torque of the engine 1. Thus, the first motor 2 is a motor-generator that is switched between a motor and a generator by electrically controlling the first motor 2, and an output speed and an output torque of the first motor 2 may be controlled electrically. The first motor 2 may also be used as a starter motor to start the engine 1.

Likewise, the second motor 3 may also be a motor-generator that serves not only as a motor to generate torque when driven by electricity suppled thereto, but also as a generator to generate electricity when driven by torque applied thereto from e.g. the drive wheels 7. For example, a permanent magnet type synchronous motor, and an induction motor may also be adopted as the second motor 3, and the second motor 3 is connected to the drive wheels 7 in a power transmittable manner through a differential gear unit (not shown) and a driveshaft 8. The second motor 3 is also switched between a motor and a generator by electrically controlling the second motor 3, and an output speed and an output torque of the second motor 3 may also be controlled electrically.

The battery 4 is a secondary battery that supplies electricity to the first motor 2, and the electricity generated by the first motor 2 is accumulated in the battery 4. For these purposes, the battery 4 is connected to the first motor 2 to exchange electricity therebetween. That is, the battery 4 may be charged with the electricity generated by the first motor 2. The battery 4 is also connected to the second motor 3 so that electricity accumulated in the battery 4 is supplied to the second motor 3 to operate the second motor 3 as a motor, and the battery 4 is charged with the electricity generated by the second motor 3. The first motor 2 and the second motor 3 are electrically connected to each other through the battery 4 and an inverter (not shown) so that the electricity generated by the first motor 2 is supplied directly to the second motor 3 to operate the second motor 3 as a motor.

According to the embodiment shown in FIG. 1, the battery 4 may be charged by an external power source through a charger (not shown). That is, the control system according to the embodiment may also be applied to a plug-in hybrid vehicle.

The detector 5 comprises sensors and devices that detect or calculate a speed of the vehicle Ve, an output power required by a driver, operating conditions of the engine 1, the first motor 2, and the second motor 3, a temperature of the battery 4 and so on. Specifically, the detector 5 comprises: a wheel speed sensor 5a that detects rotational speeds of each wheel; the accelerator position sensor 5b that detects an operation amount and an operation speed of the accelerator pedal (not shown) operated by the driver; an engine speed sensor 5c that detects a rotational speed of the output shaft la of the engine 1; a first motor speed sensor (or a resolver) 5d that detects a rotational speed of the first motor 2; a second motor sensor (or a resolver) 5e that detects a rotational speed of the second motor 3; a battery temperature sensor 5f that detects a temperature of the battery 4; a first motor temperature sensor 5g that detects a temperature of the first motor 2; a second motor temperature sensor 5h that detects a temperature of the second motor 3; a water temperature sensor 5i that detects a temperature of coolant water for cooling the engine 1; and an SOC sensor 5j that detects a state of charge (to be abbreviated as the “SOC” hereinafter) level of the battery 4. The detector 5 is electrically connected to the controller 6 so that detection values or calculation values obtained by those sensors are transmitted to the controller 6 in the form of an electric signal.

The controller 6 as an electronic control unit including a microcomputer is mainly in charge of controlling each of the engine 1, the first motor 2, the second motor 3, the battery 4, and an inverter (not shown). As described, the above-mentioned data obtained by the detector 5 is sent to the controller 6, and performs calculation using the incident data, and data and formulas and the like stored in advance. Calculation results are transmitted from the controller 6 to the engine 1, the first motor 2, the second motor 3, the battery 4, the inverter and so on in the form of command signal. Although only one controller 6 is depicted in FIG. 1, a plurality of controllers may be arranged in the vehicle Ve to control the specific devices individually.

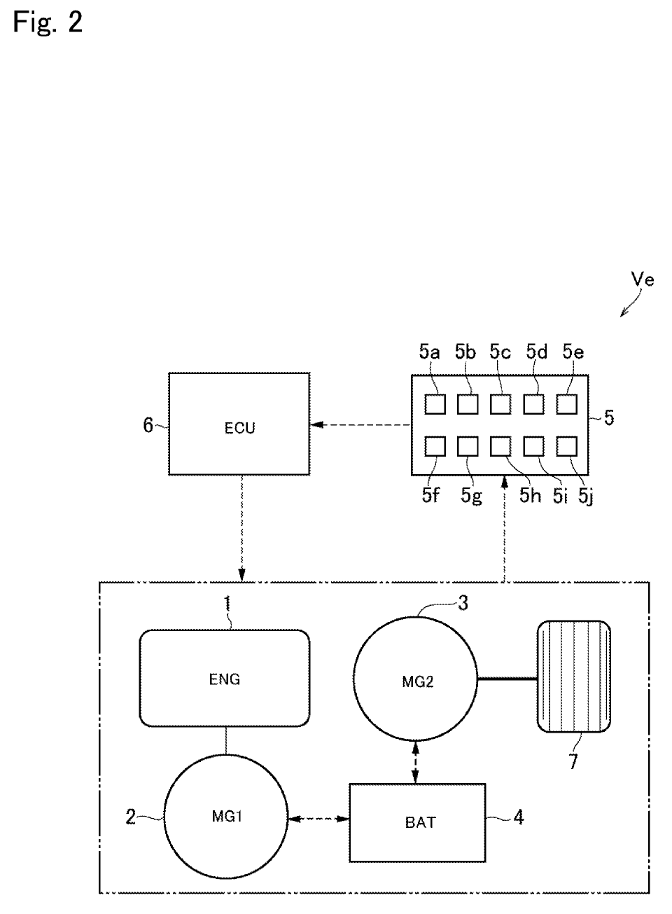

The control system according to the exemplary embodiment of the present disclosure may also be applied to a series hybrid vehicle illustrated in FIG. 2. In the vehicle Ve illustrated in FIG. 2, the prime mover also include the engine (referred to as “ENG” in FIG. 2) 1, the first motor (referred to as “MG1” in FIG. 2) 2, and the second motor (referred to as “MG2” in FIG. 2) 3. In the vehicle Ve illustrated in FIG. 2, the torque generated by the engine 1 is used only to drive the first motor 2 as a generator, and an output torque of the second motor 3 is delivered to the drive wheels 7 to establish a drive force. The remaining structures are similar to those of the vehicle Ve shown in FIG. 1, and detailed explanations for the common elements will be omitted by allotting common reference numerals thereto. Thus, the vehicle Ve illustrated in FIG. 2 is a range extender electric vehicle comprising the engine 1, the first motor 2 having a generation function, and the second motor 3 to rotate the drive wheels 7.

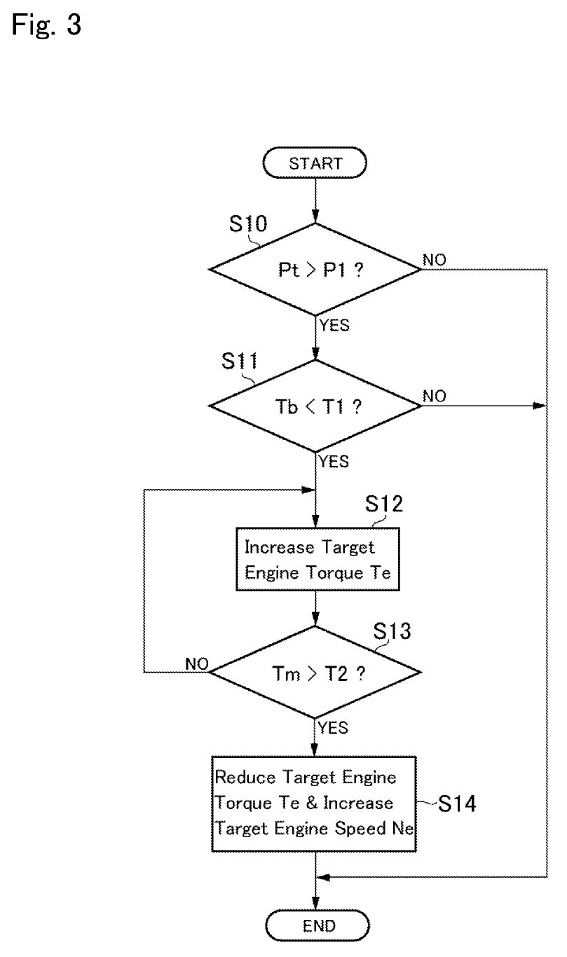

As described, it is difficult to charge the battery 4 and to discharge from the battery 4 when a temperature of the battery 4 is low, compeered to the case in which the temperature of the battery 4 is high. That is, an output performance of the battery 4 is reduced at low temperature. Therefore, when the temperature of the battery 4 is low, a required drive force may not be generated to accelerate the vehicle Ve as desired by the driver. In order to generate the drive force to propel the vehicle Ve sufficiently even at low temperature, the control system according to the exemplary embodiment is configured to increase the engine torque when a temperature of the battery 4 is low. To this end, for example, the control system according to the exemplary embodiment executes a routine shown in FIG. 3.

At step S10, it is determined whether a required output power Pt by the driver is greater than a predetermined power P1. For example, the required output power Pt may be calculated based on a vehicle speed and an operating amount of an accelerator pedal (i.e., an opening degree of an accelerator or a position of the accelerator pedal). The predetermined power P1 is a threshold value for determining whether the output power required by the drive is large, and may be set based on a result of a driving test or simulation.

If the required output power Pt is smaller than the predetermined power P1 so that the answer of step S10 is NO, the routine returns without carrying out any specific control. By contrast, if the required output power Pt is greater than the predetermined power P1 so that the answer of step S10 is YES, the routine progresses to step S11.

At step S11, it is determined whether a temperature Tb of the battery 4 is lower than a predetermined threshold level T1. To this end, the temperature Tb of the battery 4 may be detected by the battery temperature sensor 5f. The threshold level T1 is set to a level at which a performance of the battery 4 is reduced if the temperature of the battery is lower than the threshold level T1, compared to the case in which the temperature of the battery 4 is a normal temperature. If the temperature Tb of the battery 4 is lower than the threshold level T1, the controller 6 determines that the temperature Tb of the battery 4 is low and the output performance of the battery 4 is thereby reduced. The threshold level T1 may also be set based on a result of a driving test or simulation. The normal temperature is an ordinary ambient temperature at which a physical amount is stable or will not be changed significantly. For example, according to JIS Z 8703, the normal temperature is defined as a tolerable temperature range of a temperature class 15 around a standard temperature 20 degrees C., from 5 degrees C. to 35 degrees C.

As described, when the temperature is low, the output performance of the battery 4 is changed. By contrast, an output performance of the engine 1 is enhanced at low temperature as compared to the case in which the temperature falls within the normal range. Specifically, when the temperature is low, air density increases as compared to the case in which the temperature falls within the normal range so that an occurrence of knocking of the engine 1 is prevented. Given that the gasoline engine is used as the engine 1, the engine torque can be increased at low temperature by advancing an ignition timing of the engine 1. At low temperature, therefore, a maximum output torque of the engine 1 can be increased as compared to the case in which the temperature falls within the normal range. In other words, the output performance of the engine 1 can be enhanced when the temperature is low. Thus, the threshold level T1 is a criterion employed not only to determine a reduction in the output performance of the battery 4 but also to determine a possibility to enhance the output performance of the engine 1.

If the temperature Tb of the battery 4 is higher than the threshold level T1 so that the answer of step S11 is NO, the routine returns without carrying out any specific control. By contrast, if the temperature Tb of the battery 4 is lower than the threshold level T1 so that the answer of step S11 is YES, the routine progresses to step S12.

At step S12, a target engine torque Te is increased, and the engine 1 is controlled in such a manner as to achieve the increased target engine torque Te. In this situation, the first motor 2 is driven by the engine torque thus increased, and the electricity generated by the first motor 2 is accumulated in the battery 4. In other words, the battery 4 is charged with the electricity generated by the first motor 2.

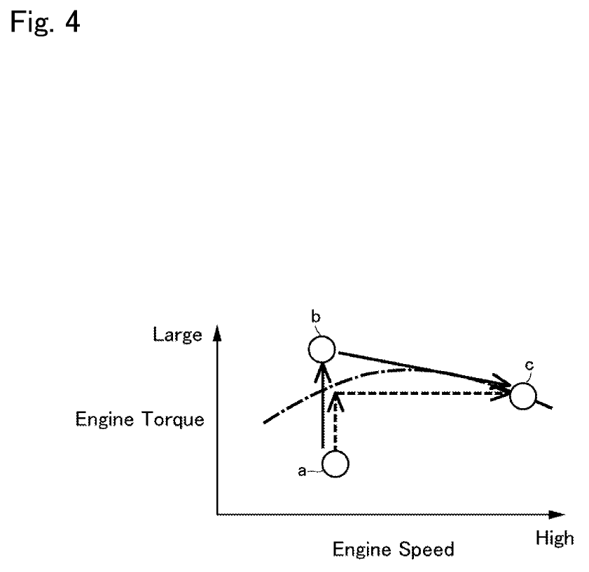

As shown in FIG. 4, an operating point of the engine 1 is governed by a load on the engine 1 such as an engine torque, and an engine speed. At step S12, specifically, the engine 1 is controlled in such a manner that a current operating point “a” of the engine 1 is shifted to a temporal point “b” at which the increased target engine torque Te is generated.

In FIG. 4, the dashed-dotted curve represents one example of a performance curve of the engine 1 as an Otto cycle gasoline engine, and in a normal condition, the engine 1 is controlled in such a manner that the operating point falls within a range defined by the performance curve as an upper limit value. That is, in a case that the temperature falls within the normal range, the engine torque and the engine speed are controlled in such a manner that the operating point of the engine 1 falls within the range defined by the performance curve. By contrast, at step S12, the operating point of the engine 1 is shifted temporarily to the temporal point “b” set higher than the performance curve, and the engine torque and the engine speed are controlled on the basis of the temporal point “b”. In this situation, since the temperature is low, the output performance of the battery 4 is reduced, but the output performance of the engine 1 is enhanced. For this reason, the engine 1 is temporarily allowed to generate torque greater than the performance curve.

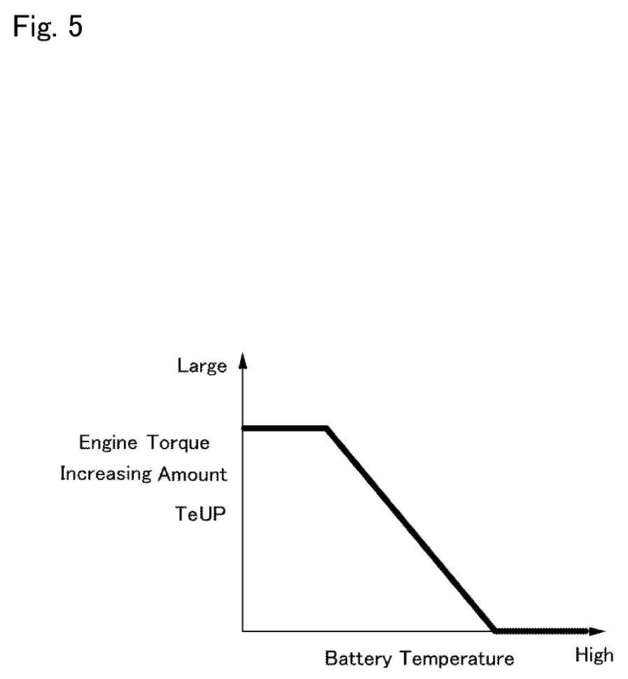

Instead of steps S11 and S12, an increasing amount of the engine torque may also be determined in accordance with the temperature Tb of the battery 4 with reference to a map shown in FIG. 5 defining a relation between an increasing amount TeUP of the engine torque and the temperature Tb of the battery 4. In this case, the increasing amount TeUP of the engine torque is increased with a reduction in the temperature Tb of the battery 4 within a predetermined temperature range between a temperature Tb1 and a temperature Tb2. In this case, at step S12, the engine torque is increased in the amount of the increasing amount TeUP thus determined based on the temperature Tb of the battery 4. In this case, the engine torque may be increased properly without excess and deficiency.

Then, at step S13, it is determined whether a temperature Tm of the first motor 2 is higher than a predetermined threshold level T2. The temperature Tm of the first motor 2 may be detected by the first motor temperature sensor 5g. The threshold level T2 is set to a level possible to determine that the temperature Tm of the first motor 2 is raised to near a maximum allowable level if the temperature Tm of the first motor 2 is higher than the threshold level T2. If the temperature Tm of the first motor 2 is higher than the threshold level T2, the controller 6 determines that the temperature Tm of the first motor 2 will soon be raised to the maximum allowable level or an upper limit temperature of the first motor 2. The threshold level T2 may also be set based on a result of a driving test or simulation.

If the temperature Tm of the first motor 2 is lower than the threshold level T2 so that the answer of step S13 is NO, the routine returns to step S12 to increase the engine torque again. Such determination at step S13 is repeated until the temperature Tm of the first motor 2 is raised higher than the threshold level T2. By contrast, if the temperature Tm of the first motor 2 is higher than the threshold level T2 so that the answer of step S13 is YES, the routine progresses to step S14.

At step S14, the target engine torque Te is reduced, and a target engine speed Ne is increased. Consequently, the engine 1 is controlled in such a manner as to achieve the reduced target engine torque Te and the increased target engine speed Ne. For example, as shown in FIG. 4, the operating point of the engine 1 is shifted from the temporal point “b” to a normal point “c”. Specifically, the normal point “c” is set based on the required output power Pt at normal temperature, and at the normal point “c”, the torque is smaller than that at the temporal point “b” and the speed is higher than that at the temporal point “b”. That is, as shown in FIG. 4, the normal point “c” is set on the performance curve, or within the range defined by the performance curve as the upper limit value. Thereafter, the routine returns.

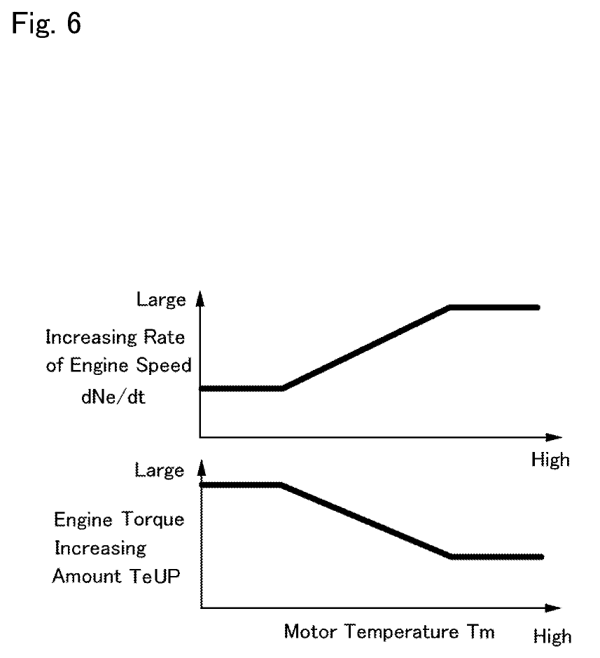

Instead of steps S13 and S14, the operating point of the engine 1 may also be shifted in accordance with the temperature Tm of the first motor 2 with reference to a map shown in FIG. 6 defining a relation between the temperature Tm of the first motor 2 and an increasing rate dNe/dt of the engine speed, and a relation between the temperature Tm of the first motor 2 and the increasing amount TeUP of the engine torque. In this case, the increasing rate dNe/dt of the engine speed is increased and the increasing amount TeUP of the engine torque is reduced with a rise in the temperature Tm of the first motor 2 within a predetermined temperature range between a temperature Tm1 and a temperature Tm2. In this case, at step S14, the engine 1 is controlled by shifting the operating point governed by the increasing rate dNe/dt of the engine speed and the increasing amount TeUP of the engine torque determined based on the detected temperature Tm of the first motor 2. In this case, the engine torque may be increased properly, and an overheating of the first motor 2 can be prevented.

Thus, if a large power is required when the output performance of the battery 4 is reduced due to low temperature, the control system according to the exemplary embodiment temporarily increases the engine torque to generate electricity by the first motor 2. Although the output performance of the battery 4 is reduced at low temperature, the air density is increased at low temperature. At low temperature, therefore, an occurrence of knocking may be prevented so that the output performance of the engine 1 is enhanced. For this reason, the engine torque can be increased at low temperature to increase generation amount of electricity. As a result, reduction in output power of the hybrid system and shortage of the drive force to propel the vehicle Ve can be prevented.

Specifically, if the required output power Pt is large at low temperature, the operating point of the engine 1 is shifted to the temporal point “b” to temporarily increase the engine torque, and then the operating point of the engine 1 is shifted from the temporal point “b” to the normal point “c” at which the torque is smaller than that of the temporal point “b” and the speed is higher than that of the temporal point “b”, before the temperature Tm of the first motor 2 is raised to the maximum allowable level. Consequently, a regenerative torque of the first motor 2 would be increased, and the temperature of the first motor 2 would be raised. According to the exemplary embodiment, however, the engine torque is increased to increase the regenerative torque of the first motor 2 only temporarily. Specifically, the operating point of the engine 1 is shifted from the temporal point “b” to the normal point “c” to reduce the load on the first motor 2. According to the exemplary embodiment, therefore, overheating of the first motor 2 can be prevented. In other words, the first motor 2 will not be damaged thermally.

As described, the control system according to the exemplary embodiment may be applied not only to the series-parallel hybrid vehicle shown in FIG. 1 but also to the series hybrid vehicle (or the range extender electric vehicle) shown in FIG. 2. Especially, in the case of applying the control system to the series-parallel hybrid vehicle shown in FIG. 1, the drive force and the generation amount can be increased directly by increasing the engine torque when the required output power Pt is large at low temperature. In this case, therefore, reduction in the output power of the hybrid system can be compensated at low temperature by the drive force and the electricity thus increased.

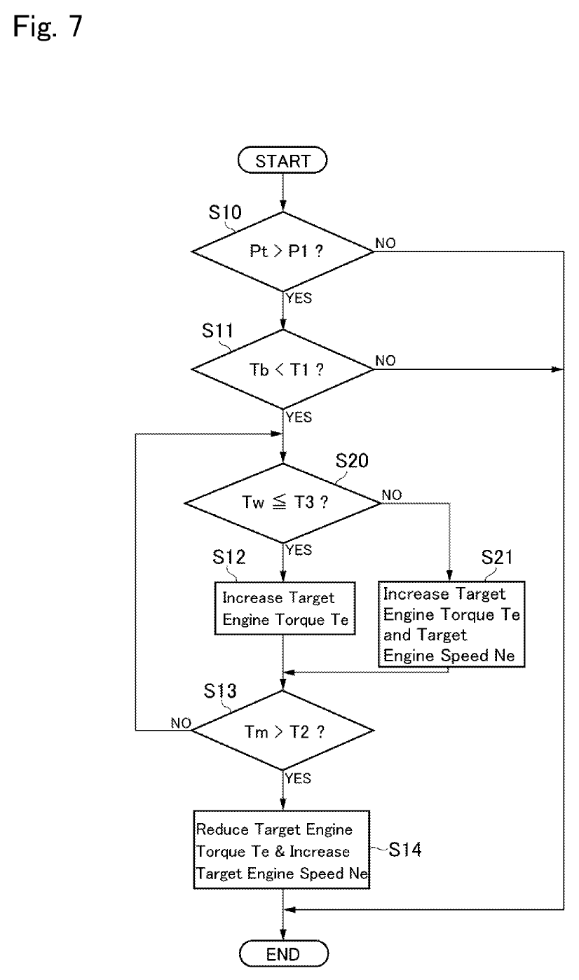

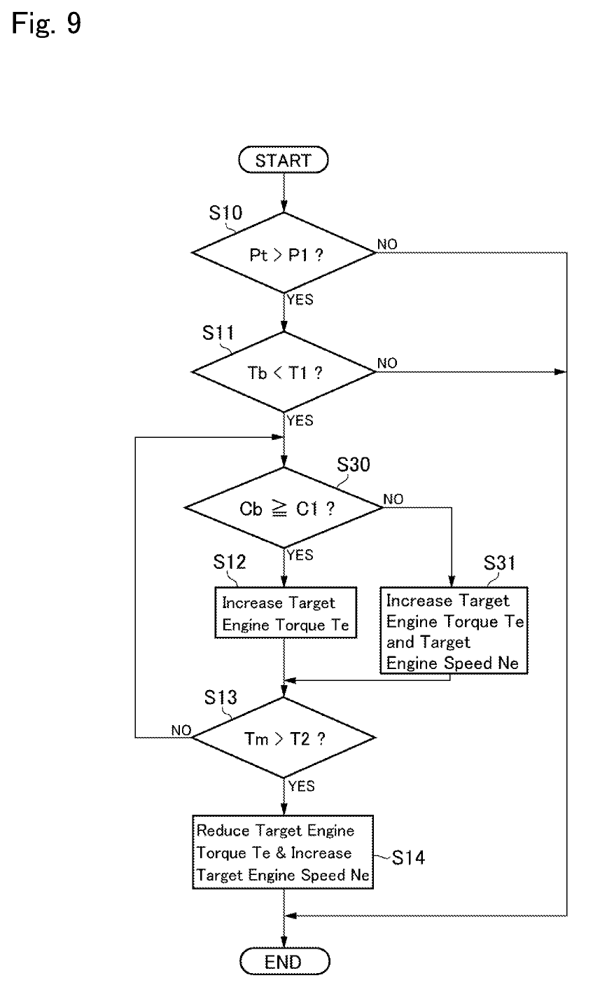

The controller 6 is further configured to execute routines shown in FIGS. 7 and 9.

FIG. 7 shows a routine for increasing an engine speed promptly when a temperature of the coolant water is high. In FIG. 7, common step numbers are assigned to the steps in common with the routine shown in FIG. 3.

If the required output power Pt is greater than the predetermined power P1 so that the answer of step S10 is YES, and if the temperature Tb of the battery 4 is lower than the threshold level T1 so that the answer of step S11 is YES, the routine progresses to step S20.

At step S20, it is determined whether a temperature Tw of the coolant water for cooling the engine 1 (i.e., an engine water temperature) is equal to or lower than a predetermined threshold level T3. The temperature Tw of the coolant water may be detected by the water temperature sensor 5i. The threshold level T3 is set to a level possible to determine that the temperature Tw of the coolant water is raised to a level at which the output performance of the engine 1 is reduced, if the temperature Tw of the coolant water is higher than the threshold level T3. If the temperature Tw of the coolant water is higher than the threshold level T3, the controller 6 determines that knocking of the engine 1 may be caused to reduce the output performance of the engine 1. That is, the controller 6 determines that shortage of the output power to propel the vehicle Ve may be caused. The threshold level T3 may also be set based on a result of a driving test or simulation.

If the temperature Tw of the coolant water is equal to or lower than the threshold level T3 so that the answer of step S20 is YES, the routine progresses to step S12. In this case, shortage of the output power to propel the vehicle Ve will not be caused due to temperature rise of the coolant water, therefore, the above-explained steps S12, S13, and S14 are executed in order.

By contrast, if the temperature Tw of the coolant water is higher than the threshold level T3 so that the answer of step S20 is NO, the routine progresses to step S21.

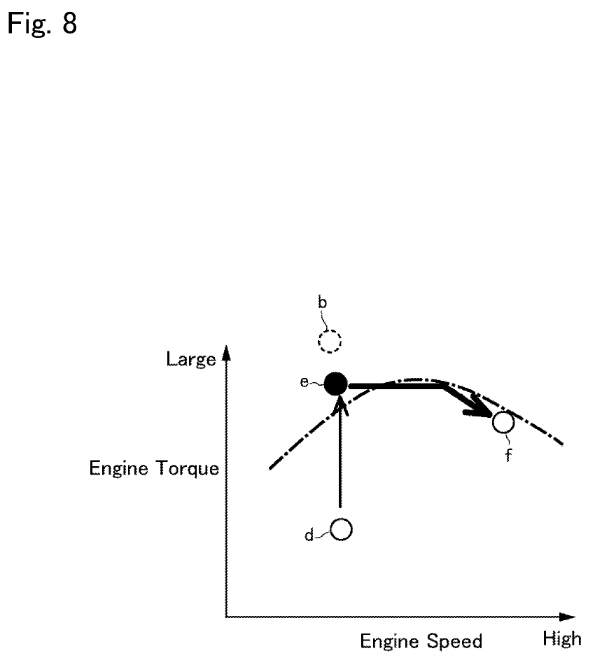

At step S21, the target engine torque Te is increased, and the target engine speed Ne is also increased promptly. Consequently, the engine 1 is controlled in such a manner as to achieve the target engine torque Te and the target engine speed Ne thus increased. For example, as shown in FIG. 8, the operating point of the engine 1 is shifted from a current operating point “d” to a temporal point “e” at which the increased target engine torque Te is generated. In this situation, since the temperature Tw of the coolant water is high, reduction in the output performance of the engine 1 is expected. Therefore, the temporal point “e” is set to a point at which the target engine torque Te is smaller than that at the temporal point “b” shown in FIG. 4. Then, the operating point is further shifted to a normal point “f” to increase the target engine speed Ne promptly. Specifically, the normal point “f” is set based on the required output power Pt at normal temperature, and at the normal point “f”, the torque is smaller than that at the temporal point “e” and the speed is higher than that at the temporal point “e”. Thus, at step S21, the engine torque is temporarily increased, and the engine speed is increased more promptly compared to the case of controlling the engine speed based on the required output power Pt at normal temperature. Thereafter, the above-explained steps S13 and S14 are executed in order.

Thus, if the temperature Tw of the coolant water is higher than the threshold level T3 when temporarily increasing the engine torque to cope with the reduction in the output performance of the battery 4 due to low temperature, the engine speed is increased more promptly compared to the case in which the temperature Tw of the coolant water is equal to or lower than the threshold level T3. If the temperature Tw of the coolant water is high, knocking of the engine 1 may be caused and hence the engine torque may not be increased sufficiently. In order to avoid such disadvantage, according to the routine shown in FIG. 7, the output power of the engine 1 is increased promptly by increasing the engine speed promptly when the temperature Tw of the coolant water is high. For this reason, shortage of the drive force to propel the vehicle Ve can be prevented.

FIG. 9 shows a routine for increasing an engine speed promptly when the SOC level of the battery 4 is low. In FIG. 9, common step numbers are also assigned to the steps in common with the routine shown in FIG. 3.

If the required output power Pt is greater than the predetermined power P1 so that the answer of step S10 is YES, and if the temperature Tb of the battery 4 is lower than the threshold level T1 so that the answer of step S11 is YES, the routine progresses to step S30.

At step S30, it is determined whether the SOC level Cb of the battery 4 is higher than a predetermined threshold level C1. The SOC level Cb of the battery 4 may be detected by the SOC sensor 5j. The threshold level C1 is set to a level possible to determine that the SOC level Cb of the battery 4 falls to a level at which the shortage of the output power to propel the vehicle Ve is expected to be caused, if the SOC level Cb of the battery 4 is equal to or lower than the threshold level C1. If the SOC level Cb of the battery 4 is equal to or lower than the threshold level C1, the controller 6 determines that the output performance if the battery 4 is reduced to cause the shortage of the drive force to propel the vehicle Ve. The threshold level C1 may also be set based on a result of a driving test or simulation.

If the SOC level Cb of the battery 4 is higher than the threshold level C1 so that the answer of step S30 is YES, the routine progresses to step S12. In this case, shortage of the output power to propel the vehicle Ve will not be caused due to reduction of the SOC level Cb of the battery 4, therefore, the above-explained steps S12, S13, and S14 are executed in order.

By contrast, if the SOC level Cb of the battery 4 is equal to or lower than the threshold level C1 so that the answer of step S30 is NO, the routine progresses to step S31.

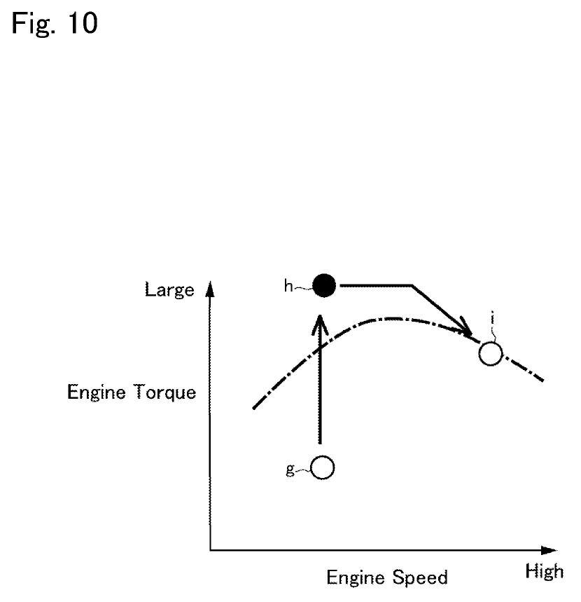

At step S31, the target engine torque Te is increased, and the target engine speed Ne is also increased promptly. In this case, the engine 1 is controlled in such a manner as to achieve the target engine torque Te and the target engine speed Ne thus increased. For example, as shown in FIG. 10, the operating point of the engine 1 is shifted from a current operating point “g” to a temporal point “h” at which the increased target engine torque Te is generated. Then, the operating point is further shifted to a normal point “i” to increase the target engine speed Ne promptly. Specifically, the normal point “i” is set based on the required output power Pt at normal temperature, and at the normal point “i”, the torque is lower than that at the temporal point “h” and the speed is higher than that at the temporal point “h”. Thus, at step S31, the engine torque is temporarily increased, and the engine speed is increased more promptly compared to the case of controlling the engine speed based on the required output power Pt at normal temperature. Thereafter, the above-explained steps S13 and S14 are executed in order.

Thus, if the SOC level Cb of the battery 4 is lower than the threshold level C1 when temporarily increasing the engine torque to cope with the reduction in the output performance of the battery 4 due to low temperature, the engine speed is increased more promptly compared to the case in which the SOC level Cb of the battery 4 is higher than the threshold level C1. If the SOC level Cb of the battery 4 is lower than the threshold level C1, shortage of the output power to propel the vehicle Ve may be caused. In order to avoid such disadvantage, according to the routine shown in FIG. 9, the output power of the engine 1 is increased promptly by increasing the engine speed promptly to raise the SCO level of the battery 4. For this reason, shortage of the drive force to propel the vehicle Ve can be prevented.

Although the above exemplary embodiments of the present disclosure have been described, it will be understood by those skilled in the art that the present disclosure should not be limited to the described exemplary embodiments, and various changes and modifications can be made within the scope of the present disclosure.

What is claimed is:

1. A control system for a hybrid vehicle comprising:
an engine;
a first motor that has a generation function, and that translates an output power of the engine into an electric power;
a secondary battery that is charged with the electric power generated by the first motor; and
a second motor that translates an electric power supplied from the secondary battery into torque to be delivered to drive wheels to establish a drive force,
the control system comprising:
a controller that controls the engine, the first motor, the second motor, and the secondary battery,
wherein the controller is configured to increase an output torque of the engine compared to an output torque of the engine to be generated to achieve a required output power by a driver at normal temperature thereby operating the first motor to generate an electric power, when the required output power is greater than a predetermined power, and output performances of the secondary battery and the engine are changed due to low temperature.

2. The control system for the hybrid vehicle as claimed in claim 1, wherein the controller is further configured to
shift an operating point of the engine temporarily from a current point to a temporal point at which the output torque of the engine is increased when a temperature is low, and
further shift the operating point from the temporal point to a normal point, which is set based on the required output power at the normal temperature, and at which the output torque of the engine is smaller than that at the temporal point and a speed of the engine is higher than that at the temporal point.

3. The control system for the hybrid vehicle as claimed in claim 2, wherein the controller is further configured to shift the operating point of the engine from the temporal point to the normal point before a temperature of the first motor reaches a predetermined level.

4. The control system for hybrid vehicle as claimed in claim 1, wherein the controller is further configured to temporarily increase the output torque of the engine, and to increase the speed of the engine more promptly compared to a case of controlling the speed of the engine based on the required output power at the normal temperature, when a temperature of coolant water for cooling the engine is equal to or higher than a predetermined level.

5. The control system for hybrid vehicle as claimed in claim 1, wherein the controller is further configured to temporarily increase the output torque of the engine, and to increase the speed of the engine more promptly compared to a case of controlling the speed of the engine based on the required output power at the normal temperature, when a state of charge level of the secondary battery is equal to or lower than a predetermined level.

6. The control system for hybrid vehicle as claimed in claim 1, wherein the engine is used not only to drive the first motor by the output torque generated by the engine, but also to establish the drive force by delivering the output torque generated by the engine to the drive wheels.
